(19) United States
(12) Patent Application Publication
(10) Pub. No.: US 2023/0040073 A1
(43) Pub. Date: Feb. 9, 2023

(54) STEER BY WIRE TYPE STEERING APPARATUS

(71) Applicant: MANDO CORPORATION, Gyeonggi-do (KR)

(72) Inventor: WooJin SHIN, Gyeonggi-do (KR)

(21) Appl. No.: 17/876,535

(22) Filed: Jul. 29, 2022

(30) Foreign Application Priority Data
Aug. 6, 2021 (KR) 10-2021-0103953

(51) Int. Cl. B62D 5/04; B62D 5/00

(52) U.S. Cl. CPC B62D 5/0445; B62D 5/001

(57) ABSTRACT

A steer by wire type steering apparatus according to the embodiments of the present disclosure may comprise a screw shaft having an outer screw portion formed on an outer circumferential surface and rotating in association with a steering shaft, a moving member having an inner screw portion corresponding to the outer screw portion formed on the inner circumferential surface, coupled to the outer circumferential surface of the screw shaft, moving in the axial direction when the screw shaft is rotated, and provided with a radially protruding guide portion on the outer circumferential surface, and a housing provided with a guide groove in which the guide portion is inserted and supported on an inner circumferential surface.

### CROSS REFERENCE TO RELATED APPLICATION

This application claims the benefit and priority from Korean Patent Application No. 10-2021-0103953, filed in the Republic of Korea on Aug. 6, 2021, the entire contents of which are hereby incorporated by reference for all purposes as if fully set forth into the present application.

### BACKGROUND

### Technical Field

Embodiments of the present disclosure relate to a steer by wire type steering apparatus, and more particularly, to a steer by wire type steering apparatus capable of mechanically stopping the steering wheel from rotating further when the rotation of the vehicle wheel reaches its maximum point and to a steer by wire type steering apparatus capable of providing steering reaction force even when an error occurs in a motor or electronic control device.

### Description of the Related Art

In general, power steering has been developed and applied to a vehicle steering apparatus to provide convenience in driving operation by assisting a driver's operating force of a steering wheel. Power steering was developed and applied in hydraulic type using hydraulic pressure, electro-hydraulic type using hydraulic pressure and electric power of the motor at the same time, and electric type using only electric power of the motor.

Recently, instead of removing a mechanical connection device such as a steering column or a universal joint or a pinion shaft between the steering wheel and the vehicle wheel, the Steer By Wire (SBW) type steering apparatus for steering a vehicle using an electric motor has been developed and applied.

However, in the case of such a steer by wire type steering system, since there is no mechanical connection between the steering shaft and the vehicle wheels, the driver's steering wheel rotation can rotate indefinitely, thereby reducing the driver's steering feeling and steering stability.

In addition, in the steer by wire type steering system, when a malfunction or inability of a motor or an electronic control device occurs, a steering reaction force cannot be generated, thereby deteriorating the driver's steering feel and steering stability.

Therefore, when the rotation of the vehicle wheel reaches its maximum point (when the steering wheel or the vehicle wheel is in a full-turn state in a general steering system), there is a need for research to prevent the steering wheel from rotating any more. Even if an error occurs in the motor or electronic control device, the need for research to prevent the driver's steering feeling and steering stability from being deteriorated is emerging.

### SUMMARY

Embodiments of the present disclosure provide a steer by wire type steering apparatus capable of increasing a driver's steering feel and steering stability by preventing the steering wheel from mechanically rotating anymore when the rotation of the vehicle wheel reaches the maximum point.

And embodiments of the present disclosure provide a steer by wire type steering apparatus capable of increasing a driver's steering feel and steering stability by generating a physical steering reaction force even if a motor or electronic control device malfunctions or fails.

In addition, the purpose of the embodiments of the present disclosure are not limited thereto, and other objects not mentioned will be clearly understood by those skilled in the art from the following description.

A steer by wire type steering apparatus according to the embodiments of the present disclosure may comprise a screw shaft having an outer screw portion formed on an outer circumferential surface and rotating in association with a steering shaft, a moving member having an inner screw portion corresponding to the outer screw portion formed on the inner circumferential surface, coupled to the outer circumferential surface of the screw shaft, moving in the axial direction when the screw shaft is rotated, and provided with a radially protruding guide portion on the outer circumferential surface, and a housing provided with a guide groove in which the guide portion is inserted and supported on an inner circumferential surface.

According to the embodiments of the present disclosure, there is provided a steer by wire type steering apparatus that increases a driver's steering feel and steering safety by preventing the steering wheel from mechanically rotating any more when the rotation of the vehicle wheel reaches the maximum point.

In addition, according to the embodiments of the present disclosure, there is provided a steer by wire type steering apparatus that increases a driver's steering feel and steering stability by generating a physical steering reaction force even if a motor or electronic control device malfunctions or fails.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a schematic view illustrating a steer by wire type steering apparatus according to the embodiments of the present disclosure;

FIG. 2 is a perspective view illustrating a steer by wire type steering apparatus according to the embodiments of the present disclosure;

FIGS. 3 to 8 are exploded perspective views illustrating a steer by wire type steering apparatus according to the embodiments of the present disclosure;

FIG. 9 is a front view illustrating a steer by wire type steering apparatus according to the embodiments of the present disclosure;

FIG. 10 is a cross-sectional view illustrating a steer by wire type steering apparatus according to the embodiments of the present disclosure.

### DETAILED DESCRIPTION

In the following description of examples or embodiments of the present disclosure, reference will be made to the accompanying drawings in which it is shown byway of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms maybe used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

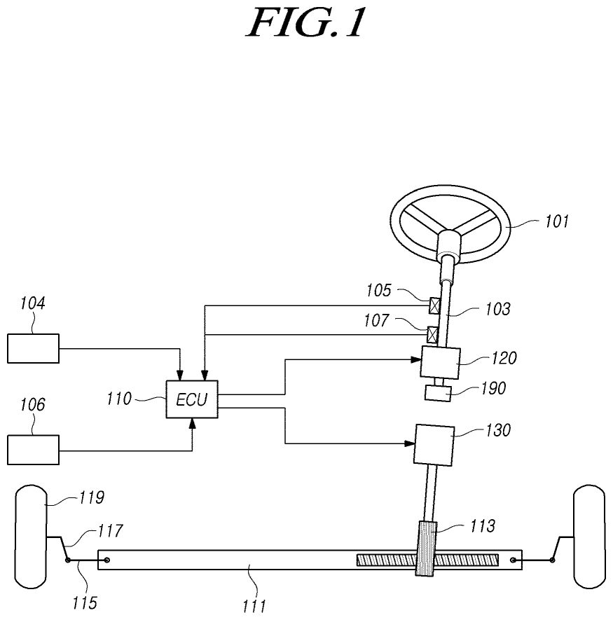

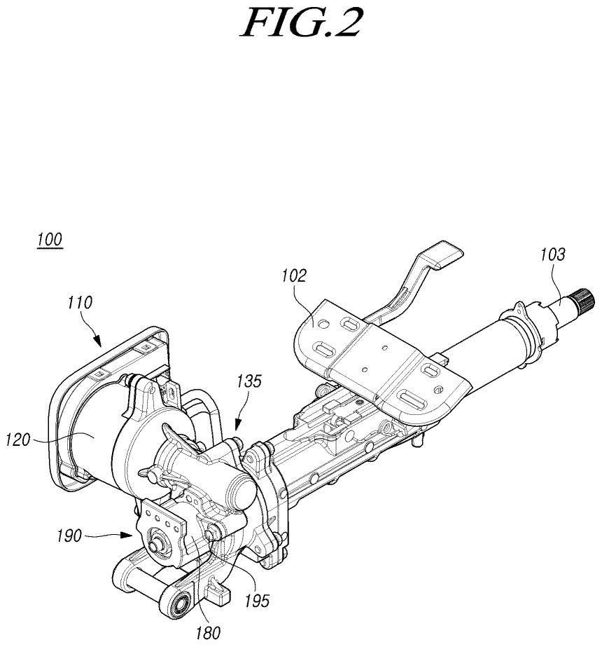

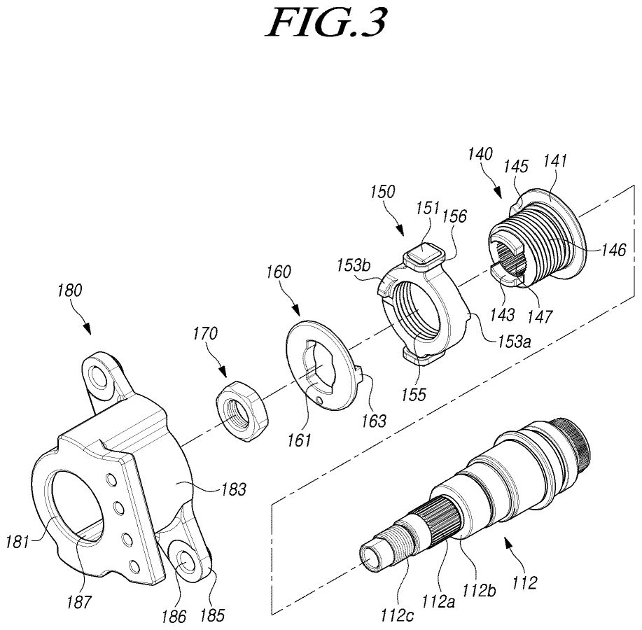

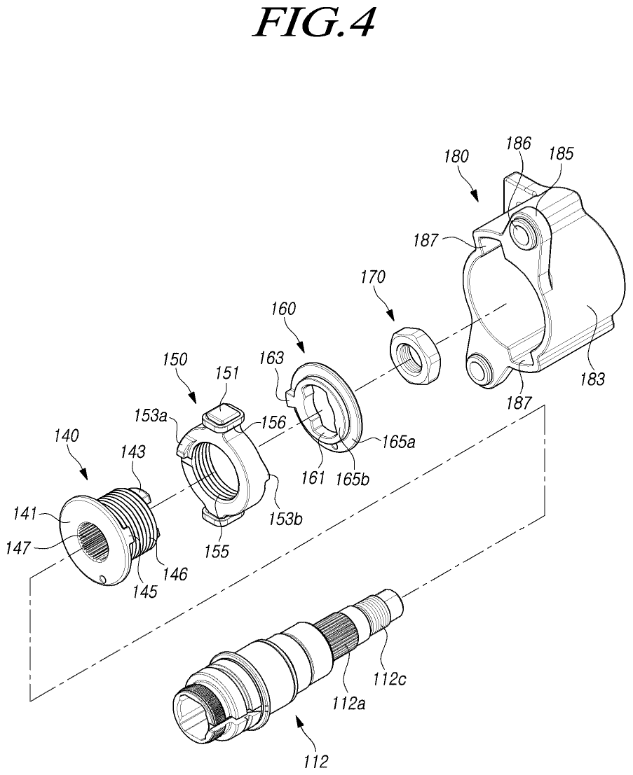

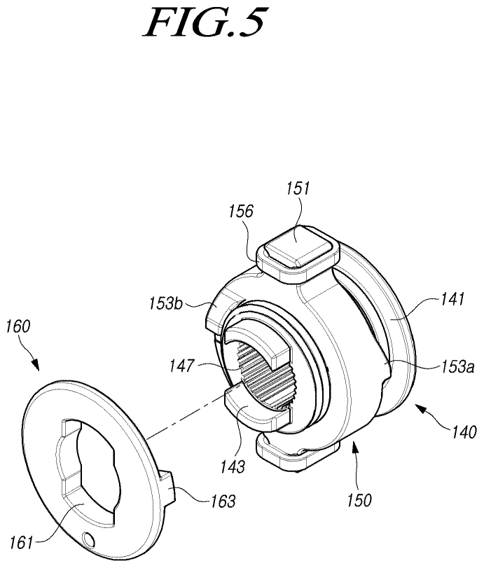

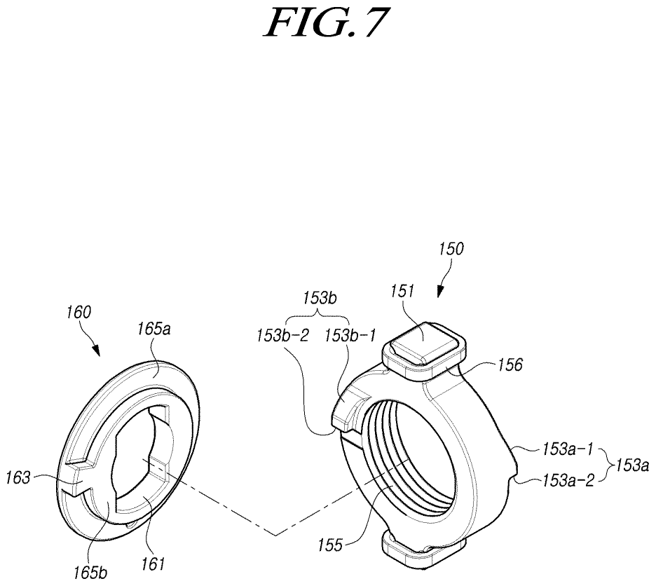

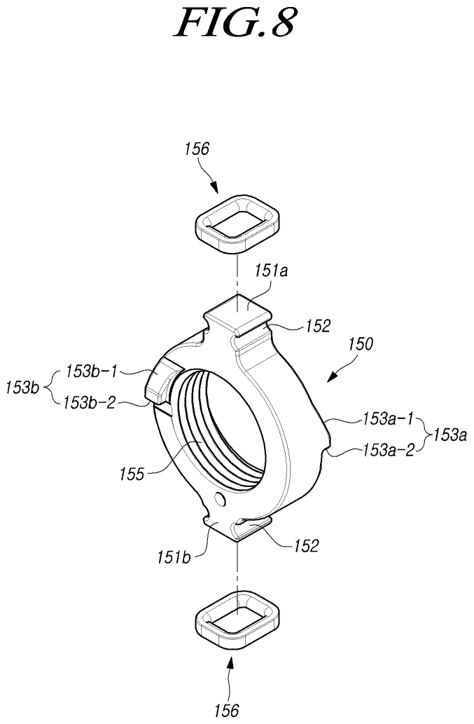

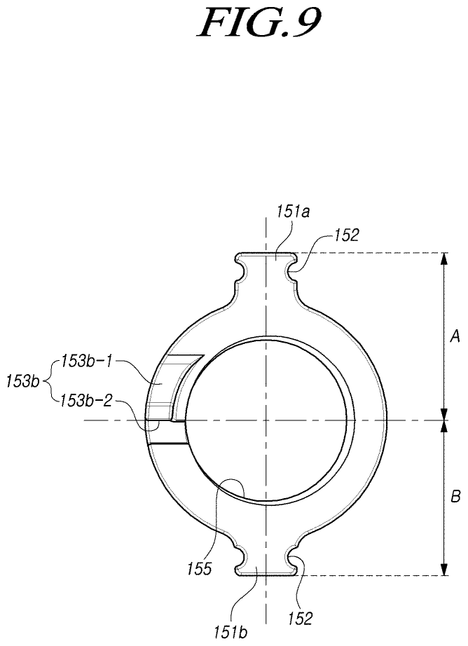

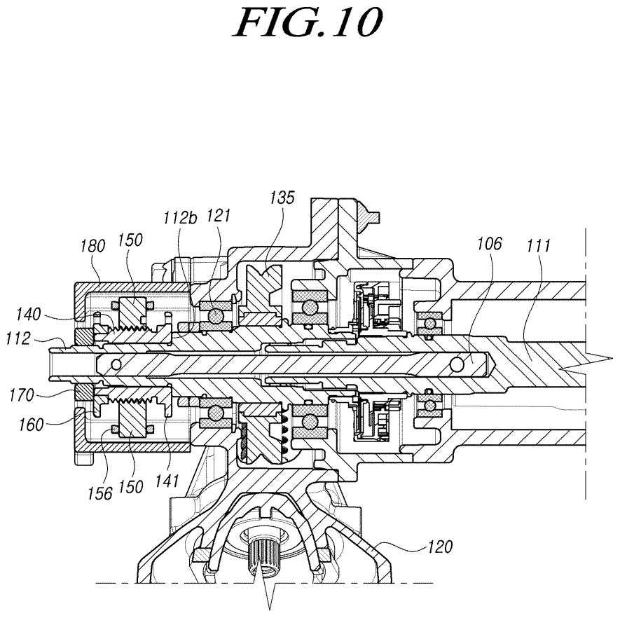

FIG. 1 is a schematic view illustrating a steer by wire type steering apparatus according to the embodiments of the present disclosure, FIG. 2 is a perspective view illustrating a steer by wire type steering apparatus according to the embodiments of the present disclosure, FIGS. 3 to 8 are exploded perspective views illustrating a steer by wire type steering apparatus according to the embodiments of the present disclosure, FIG. 9 is a front view illustrating a steer by wire type steering apparatus according to the embodiments of the present disclosure, FIG. 10 is a cross-sectional view illustrating a steer by wire type steering apparatus according to the embodiments of the present disclosure.

Referring to FIGS. 1 to 10, a steer by wire type steering apparatus according to the embodiments of the present disclosure may include a screw shaft having an outer screw portion 146 formed on an outer circumferential surface and rotating in association with a steering shaft 103, a moving member 150 having an inner screw portion 155 corresponding to the outer screw portion 146 formed on the inner circumferential surface, coupled to the outer circumferential surface of the screw shaft 140, moving in the axial direction when the screw shaft 140 is rotated, and provided with a radially protruding guide portion 151 on the outer circumferential surface, and a housing 180 provided with a guide groove 187 in which the guide portion 151 is inserted and supported on an inner circumferential surface.

First, referring to FIG. 1, in the steer by wire type steering apparatus according to embodiments of the present disclosure, an angle sensor 105 and a torque sensor 107 are coupled to one side of a steering shaft 103 connected to the steering wheel 101, and the angle sensor 105 and the torque sensor 107 that detect the driver's manipulation of the steering wheel 101 send electrical signals to the electronic control device 110 to operate a steering shaft motor 120 and a pinion shaft motor 130.

The electronic control device 110 controls the steering shaft motor 120 and the pinion shaft motor 130 based on the electrical signals transmitted from the angle sensor 105 and the torque sensor 107 and the electrical signals transmitted from other sensors mounted on the vehicle.

The steering shaft motor 120 is connected to a speed reducer 135 for reducing the number of revolutions of the motor, and provides a reaction force to the steering shaft 103 so as to feel a steering reaction force in the opposite direction when the driver operates the steering wheel 101 during normal driving. And during autonomous driving, steering is performed by the control of the electronic control device 110 without the driver's will.

The pinion shaft motor 130 slides the rack bar 111 connected to the pinion shaft 113 to steer the vehicle wheels 119 on both sides through the tie rod 115 and the knuckle arm 117.

However, in the drawings in the embodiments of the present disclosure, for convenience of explanation, the angle sensor 105 and the torque sensor 107, a vehicle speed sensor 104 for transmitting steering information to the electronic control device 110, and a wheel rotation angle sensor 106 are illustrated as an example, but a motor position sensor, various radars, lidar, and image sensors such as cameras may be provided, and a detailed description thereof will be omitted below.

In such a steer by wire type steering apparatus, since the steering wheel 101 and the vehicle wheel 119 are not mechanically connected, when the driver manipulates the steering wheel 101, a mechanical restriction is required to stop the rotation of the steering wheel 101 at a certain angle.

That is, when the rotation of the vehicle wheel 119 reaches the maximum point (in a general steering device, when the steering wheel 101 or the vehicle wheel 119 is in a full-turn state), the rotation angle limiting member 190 for mechanically limiting the rotation angle of the steering shaft 103 is provided so that the steering wheel 101 is not rotated any more. Thus, it provides the driver with an accurate steering feeling.

The rotation angle limiting member 190 may include a screw shaft 140 provided at the lower end of a steering column 100 and rotating in conjunction with the steering shaft 103, a moving member 150 that moves in the axial direction when the screw shaft 140 rotates, a housing 180 in which the screw shaft 140 and the moving member 150 are built in and coupled to the lower end of the steering column 100.

The screw shaft 140 rotates in conjunction with the steering shaft 103, and an outer screw portion 146 is formed on the outer circumferential surface, and the moving member 150 is coupled to the outer periphery of the screw shaft 140 to move in the axial direction.

The moving member 150 is coupled to the outer circumferential side of the screw shaft 140, the inner screw portion 155 corresponding to the outer screw portion 146 of the screw shaft 140 is formed on the inner circumferential surface so that when the screw shaft 140 rotates, the moving member 150 moves in the axial direction.

And, an outer peripheral surface of the moving member 150 is provided with a guide portion 151 protruding in the radial direction, the guide portion 151 is inserted and supported in the guide groove 187 formed inside the housing 180.

The housing 180 in which the screw shaft 140 and the moving member 150 are built in is coupled to the speed reducer 135 provided at the lower end of the steering column 100. A guide groove 187 is provided on an inner circumferential surface of the housing 180 to support the guide portion 151 of the moving member 150 and guide the axial movement of the moving member 150.

The housing 180 is formed in a substantially cylindrical shape, includes a body 183 formed in a cylindrical shape in which the screw shaft 140 and the moving member 150 are embedded, and a fastening flange 185 formed at one end of the body 183 and provided with a fastening hole 186.

This housing 180 is coupled to the speed reducer 135 provided at the lower portion of the steering column 100 with a fastening member 195 penetrating the fastening hole 186, and an opening hole 181 is formed at the other end of the body 183 to allow the steering shaft 103 to pass therethrough.

On one side of the axial direction of the screw shaft 140, an enlarged end portion 141 is provided with an enlarged diameter. Therefore, one side of the moving member 150 that moves when the screw shaft 140 rotates is supported by the enlarged end portion 141 and can be stopped.

Then, an inner surface of the enlarged end portion 141 is provided with a first locking protrusion 145 protruding in the axial direction, and a first support protrusion 153a protruding in the axial direction is provided on one side surface of the moving member 150.

Therefore, when the moving member 150 moves in the axial direction, the first locking protrusion 145 of the enlarged end portion 141 is supported by the first support protrusion 153a of the moving member 150 and the axial movement of the moving member 150 is stopped.

Here, the first support protrusion 153a is formed to form an inclined surface 153a-1 in which the amount of protrusion in the axial direction from one side of the moving member 150 is gradually increased in the circumferential direction, so that the first support protrusion 153a is prevented from being deformed or damaged due to continuous impact with the first locking protrusion 145. And, an end portion 153a-2 of the first support protrusion 153a is formed to be perpendicular to one side of the moving member 150.

In addition, both circumferential side surfaces of the first locking protrusion 145 are formed to protrude perpendicular to an inner surface of the enlarged end portion 141, so that those are vertically supported by an end portion 153a-2 of the first support protrusion 153a.

Also, an extension end 143 extending in the axial direction is provided on the other side of the screw shaft 140 in the axial direction, and a support member 160 on which the other side of the moving member 150 is supported is coupled to the extended end 143.

A fixing member 170 for supporting the support member 160 and the screw shaft 140 in the axial direction is coupled to an end of the steering shaft 103, and a screw portion 112c to which the fixing member 170 is screwed is provided at an end of the steering shaft 103.

The support member 160 is formed with a through hole 161 to which the extended end 143 is coupled to the central portion. A second locking protrusion 163 protruding in the axial direction is provided on an inner surface of the support member 160, and a second support protrusion 153b protruding in the axial direction is provided on the other side of the moving member 150.

When the moving member 150 moves in the axial direction, the second locking protrusion 163 of the support member 160 is supported by the second support protrusion 153b of the moving member 150, and rotation of the screw shaft 140 is limited. Therefore, the axial movement of the moving member 150 is limited.

Here, the support member 160 is formed in a disk shape in which the large-diameter portion 165a and the small-diameter portion 165b are connected stepwise in the axial direction. The extended end 143 is coupled to a through hole 161 penetrating the large-diameter portion 165a and the small-diameter portion 165b, and the second locking protrusion 163 is connected to an outer peripheral surface of the small-diameter portion 165b.

The second support protrusion 153b is formed to form an inclined surface 153b-1 in which the amount of protrusion in the axial direction from the other side surface of the moving member 150 is gradually increased in the circumferential direction. An end portion 153b-2 of the second support protrusion 153b is formed to be perpendicular to the other side surface of the moving member 150.

In addition, both circumferential side surfaces of the second locking protrusion 163 are formed to protrude perpendicular to an inner surface of the support member 160, so that those are vertically supported by an end portion 153b-2 of the second support protrusion 153b.

The guide portion 151 formed on an outer peripheral surface of the moving member 150 maybe provided in plurality, the guide groove 187 formed in the housing 180 may also be provided to correspond to the guide portion 151 in plurality.

In the present disclosure, it is shown as an example that the guide portion 151 is provided as a pair at a position symmetrically in the radial direction of the moving member 150. By being provided as a pair at such symmetrical positions, the load transmission due to the rotation of the screw shaft 140 is equally distributed to the moving member 150 and the housing 180 so that the supporting force becomes uniform.

In addition, the first support protrusion 153a formed on one side of the moving member 150 and the second support protrusion 153b formed on the other side surface of the moving member 150 are also provided as a pair at radially symmetrical positions. The first support protrusion 153a and the second support protrusion 153b are respectively disposed in the middle between the circumferential directions of the guide portion 151.

Therefore, the load transferred when the moving member 150 moves in the axial direction and stops due to the rotation of the screw shaft 140 is uniformly transferred from the middle between the circumferential directions of the guide portion 151 to the guide portion 151 on both sides and the supporting force becomes uniform.

Here, the first support protrusion 153a and the second support protrusion 153b have opposite formation directions of the inclined surfaces so that they can be supported during rotation of the screw shaft 140 in one direction and the other direction.

That is, the first support protrusion 153a is formed to increase the amount of protrusion in the circumferential direction of one side, and the second support protrusion 153b is formed to increase the amount of protrusion in the circumferential direction of the other side.

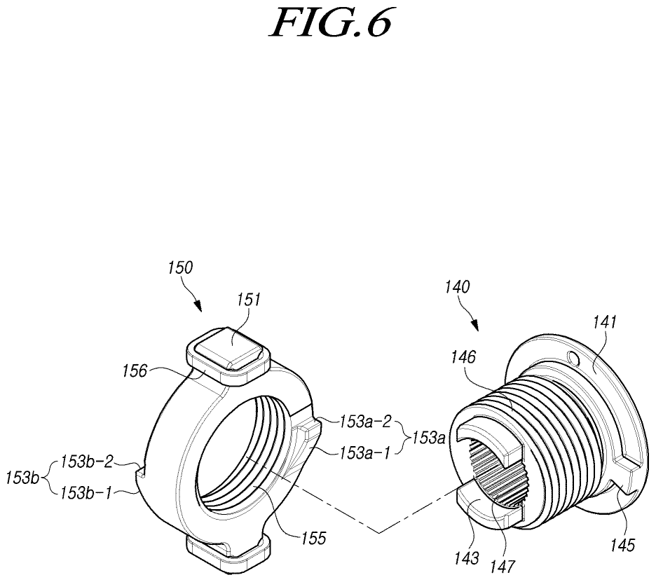

Referring to FIG. 6, as an example, the first support protrusion 153a is formed to have an increased amount of protrusion in the counterclockwise direction, and the second support protrusion 153b is formed to have an increased amount of protrusion in the clockwise direction.

Accordingly, as shown in FIG. 6, the first support protrusion 153a is vertically supported by the first locking protrusion 145 during clockwise rotation of the screw shaft 140 and the second support protrusion 153b is vertically supported by the second locking protrusion 163 when the screw shaft 140 rotates counterclockwise. Then as the rotation of the screw shaft 140 is stopped, the axial movement of the moving member 150 is also stopped.

In addition, the guide portions 151 provided as a pair may be formed to have different protrusions in the radial direction, and correspondingly, the guide groove 187 of the housing 180 is formed to have a different depth.

That is, as shown in FIG. 9, the length “A” from the center of the moving member 150 to the end of the first guide portion 151a provided on one side is greater than the length “B” from the end of the second guide portion 151b.

Therefore, when the moving member 150 and the support member 160 are integrally coupled to the screw shaft 140 and assembled together with the housing 180 on the steering shaft 103, it is possible to assemble the rotational position of the moving member 150 at an accurate position without erroneous assembly.

On the other hand, a damper ring 156 supported by the guide groove 187 of the housing 180 may be coupled to an outer surface of the guide part 151, and a seating groove 152 in which the damper ring 156 is seated may be provided on an outer surface of the guide portion 151.

Accordingly, vibration and shock in the rotational direction of the moving member 150 due to the rotation of the screw shaft 140 is absorbed by the damper ring 156, thereby eliminating vibration and noise.

The steering shaft 103 includes an output shaft 112 connected to the input shaft 111. The screw shaft 140 is coupled to an outer peripheral surface of the output shaft 112, and the input shaft 111 and the output shaft 112 are coupled via the torsion bar 106.

The outer peripheral surface of the output shaft 112 and the inner peripheral surface of the screw shaft 140 are provided with serrations 147 corresponding to each other, so that when the steering shaft 103 rotates, the output shaft 112 and the screw shaft 140 are interlocked and rotated without slipping.

A bearing 121 for supporting the rotation of the output shaft 112 is coupled between the outer peripheral surface of the output shaft 112 and the inner peripheral surface of a housing of the reducer 135. A stepped portion 112b for supporting one end of the screw shaft 140 in the axial direction is provided on the outer peripheral surface of the output shaft 112.

In addition, a fixing member 170 for supporting the other end of the screw shaft 140 and the support member 160 in the axial direction is coupled to the end of the output shaft 112 to prevent separation in the axial direction.

As described above, according to the embodiments of the present disclosure, there is provided a steer by wire type steering apparatus that increases a driver's steering feel and steering safety by preventing the steering wheel from mechanically rotating any more when the rotation of the vehicle wheel reaches the maximum point.

In addition, there is provided a steer by wire type steering apparatus that increases a driver's steering feel and steering stability by generating a physical steering reaction force even if a motor or electronic control device malfunctions or fails.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A steer by wire type steering apparatus comprising:
a screw shaft having an outer screw portion formed on an outer circumferential surface and rotating in association with a steering shaft;
a moving member having an inner screw portion corresponding to the outer screw portion formed on the inner circumferential surface, coupled to the outer circumferential surface of the screw shaft, moving in the axial direction when the screw shaft is rotated, and provided with a radially protruding guide portion on the outer circumferential surface; and
a housing provided with a guide groove in which the guide portion is inserted and supported on an inner circumferential surface.

2. The steer by wire type steering apparatus of claim 1, wherein the housing comprises:
a body formed in a cylindrical shape in which the screw shaft and the moving member are embedded; and
a fastening flange formed at one end of the body and provided with a fastening hole.

3. The steer by wire type steering apparatus of claim 2, wherein the housing is coupled to a speed reducer with a fastening member passing through the fastening hole, and an opening hole through which the steering shaft passes is formed at the other end of the body.

4. The steer by wire type steering apparatus of claim 1, wherein one side of the screw shaft in the axial direction is provided with an enlarged end portion at which one side of the movable member is supported.

5. The steer by wire type steering apparatus of claim 4, wherein a first locking protrusion protruding in the axial direction is provided on an inner surface of the enlarged end portion, and a first support protrusion protruding in the axial direction is provided on one side of the moving member, so that the first locking protrusion is supported by the first support protrusion and rotation of the moving member is limited.

6. The steer by wire type steering apparatus of claim 5, wherein the first support protrusion has an inclined surface in which the amount of protrusion in the axial direction from one side of the moving member is gradually increased in the circumferential direction.

7. The steer by wire type steering apparatus of claim 6, wherein an end portion of the first support protrusion is perpendicular to one side of the moving member.

8. The steer by wire type steering apparatus of claim 7, wherein both circumferential side surfaces of the first locking protrusion are formed to be perpendicular to an inner surface of the enlarged end portion and are supported by an end of the first support protrusion.

9. The steer by wire type steering apparatus of claim 6, wherein an extended end extending in the axial direction is provided on the other side of the screw shaft in the axial direction, and a support member on which the other side of the moving member is supported is coupled to the extended end.

10. The steer by wire type steering apparatus of claim 9, wherein a fixing member for supporting the support member and the screw shaft in an axial direction is coupled to an end of the steering shaft.

11. The steer by wire type steering apparatus of claim 9, wherein a second locking protrusion protruding in the axial direction is provided on an inner surface of the support member, and a second support protrusion protruding in the axial direction is provided on the other side of the moving member so that the second locking protrusion is supported by the second support protrusion and rotation of the moving member is restricted.

12. The steer by wire type steering apparatus of claim 11, wherein the support member is formed in a disk shape in which a large-diameter portion and a small-diameter portion are connected stepwise in the axial direction, the extended end is coupled to a through hole passing through the large-diameter portion and the small-diameter portion, and the second locking protrusion is connected to an outer circumferential surface of the small-diameter portion.

13. The steer by wire type steering apparatus of claim 11, wherein the second support protrusion is formed to form an inclined surface in which the amount of protrusion in the axial direction from the other side surface of the moving member is gradually increased in the circumferential direction, and an end portion of the second support protrusion is formed to be perpendicular to the other side surface of the moving member.

14. The steer by wire type steering apparatus of claim 13, wherein the first support protrusion is formed to increase the amount of protrusion toward one side in the circumferential direction, and the second support protrusion is formed to increase the amount of protrusion toward the other side in the circumferential direction.

15. The steer by wire type steering apparatus of claim 13, wherein both circumferential side surfaces of the second locking protrusion are formed to be perpendicular to an inner surface of the support member and are supported by an end of the second support protrusion.

16. The steer by wire type steering apparatus of claim 1, wherein the guide portion is provided in plurality on an outer peripheral surface of the moving member.

17. The steer by wire type steering apparatus of claim 1, wherein the guide portion is provided as a pair at a position symmetrically in the radial direction of the moving member.

18. The steer by wire type steering apparatus of claim 17, wherein the pair of guide portions are formed to have a different amount of protrusion in the radial direction.

19. The steer by wire type steering apparatus of claim 1, wherein a damper ring supported by the guide groove of the housing is coupled to an outer surface of the guide portion.

20. The steer by wire type steering apparatus of claim 19, wherein a seating groove in which the damper ring is seated is provided on an outer surface of the guide portion.
